(19) United States
(12) Patent Application Publication
(10) Pub. No.: US 2016/0335657 A1
(43) Pub. Date: Nov. 17, 2016

(54) METHOD AND SYSTEM FOR ATTRIBUTING TRANSACTIONS TO AN ACCOUNT

(71) Applicant: Lassu, Inc., San Francisco, CA (US)

(72) Inventor: James David Griffin, Palo Alto, CA (US)

(21) Appl. No.: 15/152,847

(22) Filed: May 12, 2016

Related U.S. Application Data
(60) Provisional application No. 62/260,186, filed on Nov. 25, 2015.

(30) Foreign Application Priority Data
May 15, 2015 (PH) 1-2015-000166

(51) Int. Cl. G06Q 30/02

(52) U.S. Cl. CPC G06Q 30/0231; G06Q 30/0229; G06Q 30/0238

(57) ABSTRACT

A method for automatically detecting, reporting and managing cases of unusual, unexpected, unauthorized or noncompliant transaction activity or points balances within a retail-based or online loyalty program, rewards program or discount scheme, wherein an hypothesis about abnormal activity may be adjusted upward or downward, based upon transaction counts and/or transaction values, in conjunction with one or more additional risk factors, which factors have different tolerances or thresholds, depending upon the sales channel, branch, store or line of business, and which factors are adjusted upward or downward, based on ad hoc groups of members. Alerts are delivered to designated person(s) responsible, with case management and tracking. An automatic second-level alert is sent to a different user, if the primary person responsible does not close the case within the amount of time designated to do so.

### BACKGROUND

1. Field

The application relates to detecting transactions that are credited to a particular person, group, or account, when said person, group, or account is not actually a party to the transaction. Detecting such transactions can be particularly relevant to loyalty or rewards programs, in which points or other benefits are awarded for purchases credited to a loyalty-rewards account.

2. Description of the Related Art

Points-based rewards programs such as customer loyalty programs, reward programs, and various discount schemes are vulnerable to employee-type fraud. One of the reasons for this is that the mechanism for earning points is not, in most cases, also the mechanism used for payment. As a result of this, a loyalty or rewards account can easily be credited for numerous, unrelated transactions and earn points or other benefits from those transactions, without any corresponding cost to the employee.

Specifically, the mechanics of many rewards programs are designed to link a rewards account to a transaction, either by swiping or scanning a card or smart device or by entering an account identifier. In cases where the card or account being linked to the transaction is not a debit or credit card/account then, in such programs, the process of linking an account to a transaction may be completely independent from the process of paying for the purchase. This is a key element in many program designs that exposes the retailer to abuse by cashiers or other employees. Additionally, many such programs credit points, or some other form of virtual currency, that can later be exchanged for items of value, therefore the rewards currency earned creates a true financial liability on the books of the company, at a funding rate defined by the rules of the program. For example, a program might state that $1 equals one point to earn, and 100 points equal $1 to redeem for rewards, which equates to a 1% funding rate for that rewards program. In such a case, revenue might be reduced by 1% when the sale is booked, and a deferred liability might be carried on the books to represent the financial obligation for the points that were awarded on that transaction. This liability, and the associated obligation to redeem points for rewards at some future date, is another key factor that creates vulnerability to abuse of such programs by cashiers or other employees, especially since the date and location of redemption for rewards can often be, and usually is, different from the date and location of the original purchase where the points were earned.

In the classic abuse scenario, cashiers retain a loyalty-rewards card that belongs to them or to a family member or friend, and credit purchases to that card when it is evident that the customer does not have a card of their own. In this way, cashiers may circumvent program rules to grant member-only discounts to non-members and/or obtain points for themselves, based on the purchases of others.

Such problems are difficult to detect. Existing methods for fraud detection in other contexts generally seek to determine whether the person making use of an account, such as a credit card or debit card account, is the “true” accountholder. Unfortunately, such methods cannot be applied to retail-based customer rewards programs, because many such programs allow users to earn points on an account that has not yet been registered, so the “true accountholder” is frequently undefined. Also, in some situations multiple cards are issued for a single account, or it is otherwise implicitly assumed that the account will be shared among multiple people, not all of whom are registered. Consequently, the concepts of verification or authentication of a “true accountholder” are inherently impossible for many loyalty-rewards programs.

In addition to financial losses from insider fraud, another very significant concern for loyalty-rewards program operators is the effect of such activity on their data models. Without a doubt, if demographics of cashiers, or their family and friends become part of a regression model for “high-value customers,” and if shopping carts of completely random non-members are aggregated together to describe the purchasing habits of this high-value group, then marketing data models will not function as intended and, in some cases, the outputs of such models could be almost meaningless. In short, the possible direct and indirect costs of cashier fraud in loyalty-rewards programs are enormous.

### SUMMARY

In the field of fraud detection, the most common focus for solutions is the real-time detection of fraudulent credit card transactions, fraudulent digital wallet payments and/or simulated online transactions. Such solutions are normally designed to prevent fraud before it occurs, while at the same time, facilitating non-fraudulent payments and transactions across various channels, including point-of-sale (“POS”) and mobile devices. In this context, attempted fraud is ideally detected in real time, to prevent the fraudulent purchaser from leaving the store with purchased goods. In the case of loyalty-rewards accounts, however, and particularly the receiving of points in loyalty-rewards programs, this is not as much of a concern. Further, in the loyalty-rewards context, there is more emphasis on not disrupting a legitimate transaction because the entire purpose of such a program is to increase customer satisfaction.

In some embodiments a method is presented, the method providing for detecting, reporting and managing cases of fraudulent transaction activity and/or points earning within a retail-based or online loyalty program, rewards program or discount scheme; and/or for detecting, reporting and managing cases of unusual points adjustment activity within a loyalty or rewards program; and/or for detecting, reporting and managing cases of unusual points transfer activity within a loyalty or rewards program; and/or for detecting, reporting and managing cases of unauthorized gift redemption activity within a loyalty or rewards program; and/or for detecting, reporting and managing cases of unexpected points balances within a loyalty or rewards program; and/or for detecting, reporting and managing cases of accounts that were promoted to a higher tier level, such as gold or elite status, without meeting the business requirements established for such status.

An embodiment can go beyond mere transaction counts, in order to develop a better and more accurate model of abnormal activity, based on one or more additional risk factors, in addition to, or instead of transaction counts and/or transaction values.

An embodiment can further modify risk scores, based on different tolerances or thresholds, depending upon the sales channel, branch, store or line of business.

An embodiment can further modify risk scores, based on ad hoc groups, for which risk levels can be adjusted, based on findings from previous investigations or for other reasons.

An embodiment can deliver an alert to the dashboard of the person designated to receive it, with access to the report via username and password, and with system tracking, to determine whether the designated recipient opened the report. Said dashboard can show current-day alerts, as well as trend data. It can be possible to view cases by category, such as Unopened, Aging, and Closed. It can be possible to view transaction history associated with reported cases, and to sort and filter the records found in the transaction history. It can be possible to drill down to transactions for any case listed, and it can be possible to drill down to transaction details as well.

An embodiment can generate a second-level alert to a different user, to flag any cases for which the primary person responsible for that case had not opened it and/or had not closed the case within the amount of time designated to do so. The user who receives the second-level alert would also be able to access all of the same report features and views described in the immediately-preceding paragraph.

An embodiment can refer to a system consisting of specialized tools for automatically detecting, reporting and managing cases of unusual, unexpected, unauthorized or noncompliant transaction activity or points balances within a retail-based or online loyalty program, rewards program or discount scheme. The specialized tools can include a Points Earning Module, a Points Adjustment Module, a Points Transfer Module, a Gift Redemption Module, a Points Exception Module, and an Upgrade Exception Module, as well as a User Management Module and an Admin Module for setting customized rules. Each module can further elaborate the approach described for detecting unusual points earning, but in different ways that are better targeted to the specific issues and vulnerabilities associated with each specific objective.

Further, the specialized tools can include a data view structure and an application database structure, both connected to a server comprising a web server and a core application, where the server is connected to a client machine via a network. Within this structure, an hypothesis about abnormal activity may be adjusted upward or downward, based upon transaction counts and/or transaction values, in conjunction with one or more additional risk factors, which factors may have different tolerances or thresholds, depending upon the sales channel, branch, store or line of business, and which factors may be adjusted upward or downward, based on ad hoc groups of members. Alerts are delivered to the designated person(s) responsible, for case management with tracking. An automatic second-level alert is sent to a different user, if the primary person responsible does not close the case within the amount of time designated to do so.

In an embodiment, a method can be provided for detecting fraudulent earning of loyalty-rewards points at physical, or “brick-and-mortar,” retail locations where the true owner of the loyalty-rewards account might not be identified. A computing system having one or more hardware processors can receive electronic data regarding a plurality of transactions associated with a specific loyalty-rewards account at one or more point-of-sale devices. The computing system can then determine a risk that the specific loyalty-rewards account was fraudulently credited for one or more transactions not made by the accountholder of the loyalty-rewards account, based at least on the electronic data. If the determined risk that the loyalty-rewards account was fraudulently credited reaches a predetermined threshold, that account can be flagged for further review by the person(s) responsible, as defined within the system.

### BRIEF DESCRIPTION OF THE DRAWINGS

In order to facilitate a more complete understanding, reference is here made to the appended drawings. These drawings should not be construed as limiting the application, but are intended only as examples.

FIG. 1 is a block diagram of a system for detecting insider-initiated fraud, showing functional relations among its components in accordance with an embodiment.

FIG. 2 is a block diagram of an Analytics Engine, showing the relations among its modules in accordance with an embodiment.

FIG. 3 (FIGS. 3A to 3L) is a flowchart illustrating an embodiment process for the Points Earning Module depicted in FIG. 2.

FIG. 4 (FIGS. 4A to 4K) is a flowchart illustrating an embodiment process for the Points Adjustment Module depicted in FIG. 2.

FIG. 5 (FIGS. 5A to 5M) is a flowchart illustrating an embodiment process for the Points Transfer Module depicted in FIG. 2.

### DETAILED DESCRIPTION

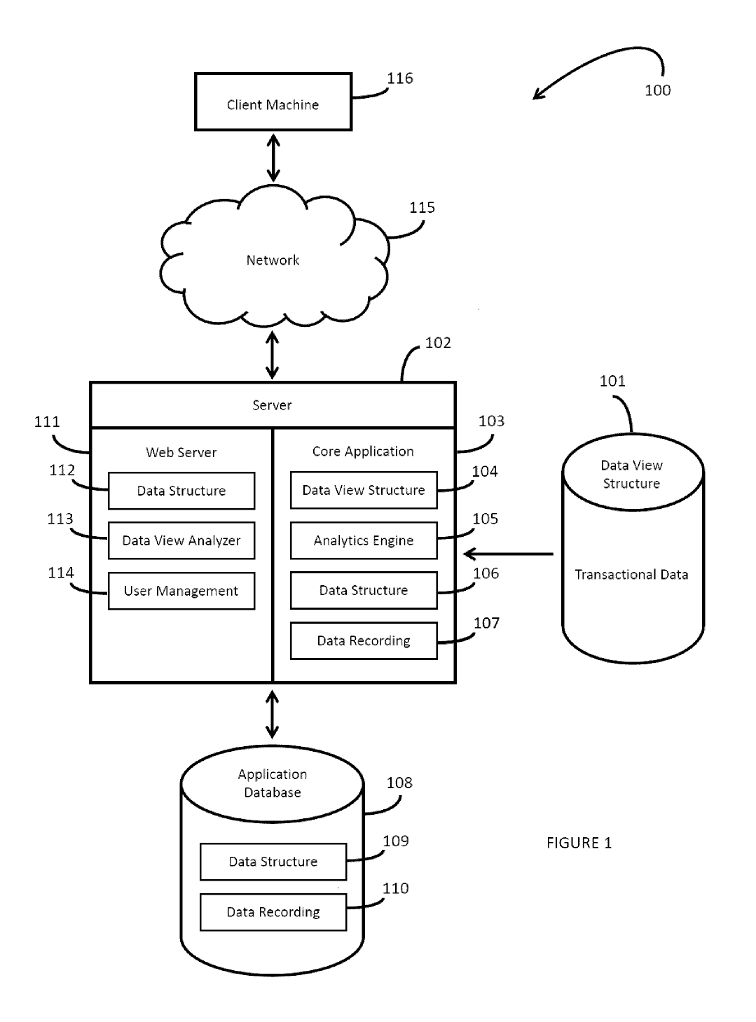

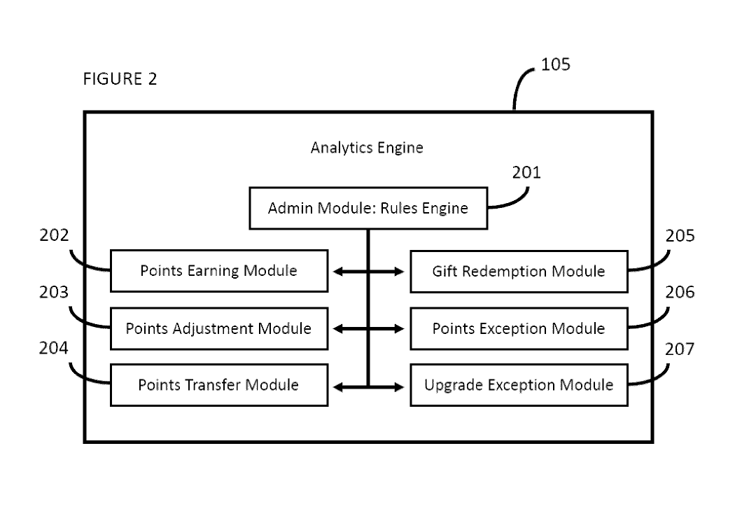

FIG. 1 is a block diagram of a system 100 that addresses common problems faced by administrators of loyalty or rewards programs, including detection of insider-initiated fraud, and/or member-discount schemes in a retail or online setting. The system 100 includes a data view structure 101 and an application database structure 108, both connected to a server 102 comprising a web server 111 and a core application 103 where the server 102 is connected to a client machine 116 via a network 115 such as the internet or a local network.

The term “insider,” as used herein, can refer to a number of potential parties. A common example, as discussed above, would be an employee in a retail setting such as a cashier. However, it will be understood that non-employee agents in a retail setting, or even persons unaffiliated with the retail store or other venue, could also feasibly commit similar fraudulent activity. Thus, it should be understood that, although this application may refer to certain specific and common fraudsters, other “insiders” could also be detected by the systems and methods described herein.

Similarly, terms such as “loyalty programs,” “rewards programs,” “member-discount schemes,” and the like can also refer to a number of different programs. A common example is found at retail stores, where a user has an account that entitles them to certain discounts, awards, prizes, and/or points for their purchases, the points being redeemable for various things. However, such accounts can be used in other settings such as in a business-to-business setting, or where a service is provided, other than physical goods. Further, such accounts can even be used in situations where the account-holder sells something to the account-provider, instead of the reverse. Other transactional relationships between the account-holder and the account-provider are also possible, and such transactional relationships may require or facilitate activities that are also subject to the various programs discussed herein. Even further, in some embodiments an account may be credited for non-financial transactions such as posting a photo or hashtag on social media, registering an account online, referring a friend or other actions. The term “loyalty-rewards” shall be used herein to describe any of these types of programs that provide certain benefits when an account is credited with some form of transaction or activity. Further, these programs are often used to collect data about customers. Thus, the systems and methods described herein can be used to correct erroneous transaction data, even if the cause of the error is not fraud, but rather some other type of error.

The nature of the “benefits” provided by the loyalty-rewards programs can vary. For example, in some programs, points (or some other numerical variable) can be added to an account, and the points can subsequently be redeemed for various things. In other embodiments, a specific reward may be provided for a single transaction, or for a specific combination of transactions, etc. Although certain embodiments herein will be described as applying to “points,” these embodiments can also be applied to methods and systems that provide other benefits, the other benefits being treated in a similar way as points.

The nature of the “account” can also vary. For example, in some embodiments the account can be associated with a particular user, having certain identifying information such as a name, telephone number, email address, credit card or other information; or can be associated with a person using an assigned identification card or account number. The accountholder can make this identifying information available at the time of the transaction, in order for the account to be credited. Notably, in many embodiments, the true identity of the accountholder is not verified, or even requested. Further, given that many such accounts are used by multiple people (for example, a family using the same account), the “accountholder” is often not a single individual. Thus, the “true” identities do not necessarily need to be determined, in order for points to be credited to an account. Similarly, multiple accounts can be identified as being associated with a single customer and grouped together accordingly. In some embodiments, this grouping can be provided with a single-customer-view identifier, which can optionally be treated in a manner similar to a single account.

The Core Application 103, depicted in FIG. 1, extracts electronic transaction data from a data view structure 101 using the Data Recording module 107 to transform the data into the required structure 106 for analysis, and then loads the transformed data to the Application Database 108. The transformed data in the Application Database 108 can be stored within the Data Structure 109 using the Data Recording module 110. The Analytics Engine 105 accesses and processes information located within the Application Database 108 and records the final results back into the Application Database 108. Display of reports begins when an authorized user logs in at a Client Machine 116, which accesses the Web Server 111 across a network 115. In response, the Data View Analyzer 113, located in the Web Server 111, accesses the Application Database 108, which passes the required information back to the Web Server 111, to a structure 112, and ultimately, to the Client Machine 116 across a network 115. The Data View Analyzer 113 also accesses information from the Application Database 108 and passes the required information and views across the network 115 to the Client Machine 116 for the case management of aging reports. The Client Machine 116 is utilized by a user for initiating the closing of a case and the entered information is passed across the network 115 to the Web Server 111 which records the information in the Application Database 108, as further described herein. A User Management module 114 can determine authenticated users and set permissions for access to the Data Structure 112 across the network 115 by a Client Machine 116.

The data from the data view structure 101 can come, for example, from a plurality of point-of-sale devices at physical retail locations, such as employee-assisted cash registers, self-service cash registers, other types of point-of-sale devices, or the data may come from internet transactions or telephone-operated sales mechanisms, or other devices configured to facilitate transactions that can be operated or assisted by employees, customers, or any other persons involved with the transactions. In some embodiments, this data can be transmitted directly into the system described herein. In other embodiments, it may be aggregated by other systems, converted into different formats, or otherwise processed prior to use with the current system.

The Analytics Engine 105 can contain a Points Earning Module 202, a Points Adjustment Module 203, a Points Transfer Module 204, a Gift Redemption Module 205, a Points Exception Module 206, and an Upgrade Exception Module 207. Further the Analytics Engine 105 can include an Admin Module 201 configured to act as a rules engine, to add or modify rules that can optionally apply to all of the modules in the Analytics Engine 105, or alternatively to a subset of said modules. Such component(s) and the steps or processes associated with each, can be multiplied for various applications or for different application environments. In addition, the modules or components can be further combined into a consolidated unit, or other architectures can be realized. The modules and/or components can be further duplicated, combined and/or separated across multiple systems at local and/or remote locations. While various functionalities are ascribed to certain individual system components, these functionalities can be differently distributed or combined among various other system components, in accordance with different embodiments. Moreover, while the various flows and processes described herein are presented in a specific order for ease of description, some procedures can be added, omitted and/or reordered, in accordance with various embodiments.

As used herein, the terms “module,” “structure,” or “engine” are units of distinct functionality that can provide information to, and receive information from, other modules. Accordingly, the described terms are regarded as being communicatively coupled. Modules, “structures,” or “engines” can also initiate communications with input or output devices, and operate on a resource, e.g., a collection of information. They can be implemented as hardware circuitry, single or multiprocessor circuits, memory circuits, software program modules and objects, firmware, and/or combinations thereof, as appropriate for the particular implementations of the various embodiments.

The various illustrative features described in connection with the embodiments disclosed herein, such as the modules, structures, engines, servers, applications, databases, and analyzers, can be implemented or performed by a machine, such as a general purpose processor, an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Notwithstanding the foregoing, this method of disclosure is not intended to communicate an intention that the claimed embodiments require more features than are expressly cited in each claim. As the following claims reflect, the subject matter of the present invention potentially lies in less than all the features of a single-disclosed embodiment; each claim stands on its own as a separate embodiment.

One or more of the components of the system or systems embodying the present invention comprise computer-readable program code in the form of functional instructions stored in a non-transitory computer-usable medium, such that when that medium is installed on the system or systems, those components cause the system to perform the functions described. The computer-readable program code for the present invention can be bundled with other computer-readable software.

Further, the process and system can be implemented within a variety of operating systems, including a Unix-based system, a Microsoft system, an IBM system, or other operating system.

Further, the user interface can be provided via the Internet, intranet or other computer networks.

Further, the main data store 101, the application data store 108 and/or other databases can reside at a single location or they can be separated in multiple locations. The structure of the database can be different from client to client, and can have more or fewer databases for the data required, and/or for different transformations, and/or for different processing environments and/or platforms. In some cases, an embodiment of the present invention can be required to synthesize or infer data that are unavailable, as such, in the source database, thereby creating one or more additional step(s).

The systems and processes described can be implemented on any general or special-purpose computational device, either as a stand-alone application or as a suite of applications. Alternatively, the systems and processes can be implemented across several general or special-purpose computational devices connected over a network as a group, operating in a client-server mode, or the system can be connected to other systems sharing a common database. In some embodiments, the computer system can also include a processing acceleration unit, which can include a digital signal processor and/or a special-purpose processor. Other hardware arrangements can also be provided.

The process and system of the present invention can be tangibly embodied in one or more physical media, including computer-usable and writable media, such as a CD-ROM, a hard drive, read-only memory (ROM), random access memory (RAM), or any other computer-usable medium, as well as any other physical media, capable of storing software and/or combinations thereof. Similarly, data modules and features such as the main data store 101 and the application data store 108 can also use such media.

While the detailed description is directed to an exemplary application involving loyalty-rewards program fraud or misuse, including inappropriate use of various discount mechanisms in a retail setting or over a telephone, the various processes and systems can also be applied to other scenarios and applications, that can require similar types of pattern recognition, such as online sales. Other applications can be applied in varying scope.

The processes and systems of the present application do not need to be restricted to the specific embodiments described herein. Other embodiments, uses, permutations and advantages are also possible. The intended scope of the application is only limited by the claims appended hereto.

### Points Earning Module

The Points Earning module is directed towards a method for the detection, reporting, and case management of unusual patterns of points earning within a loyalty-rewards program. This module can be generally directed toward any transactions that might cause an account, such as a loyalty-rewards account, to receive benefits such as points, as a result of being credited with certain transactions.

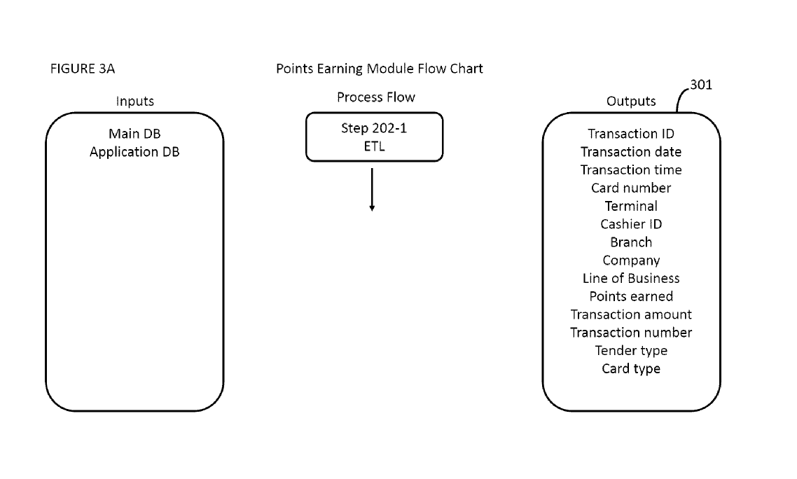

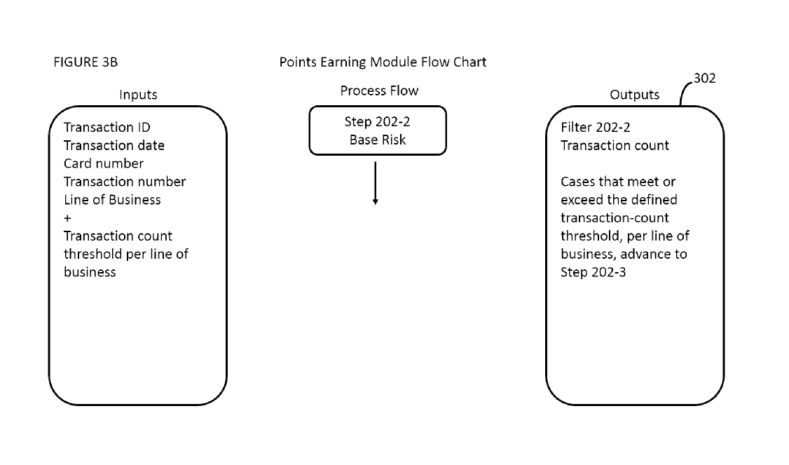

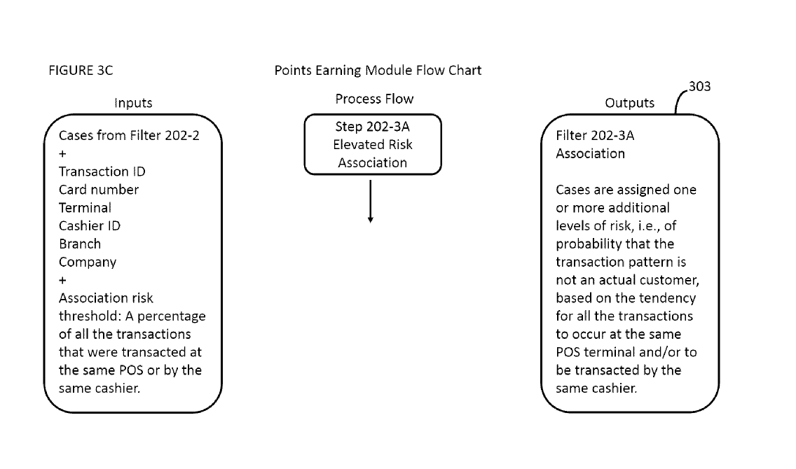

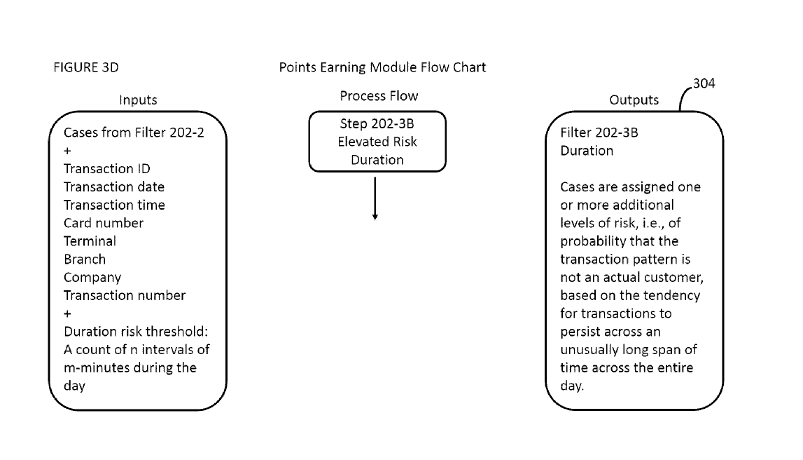

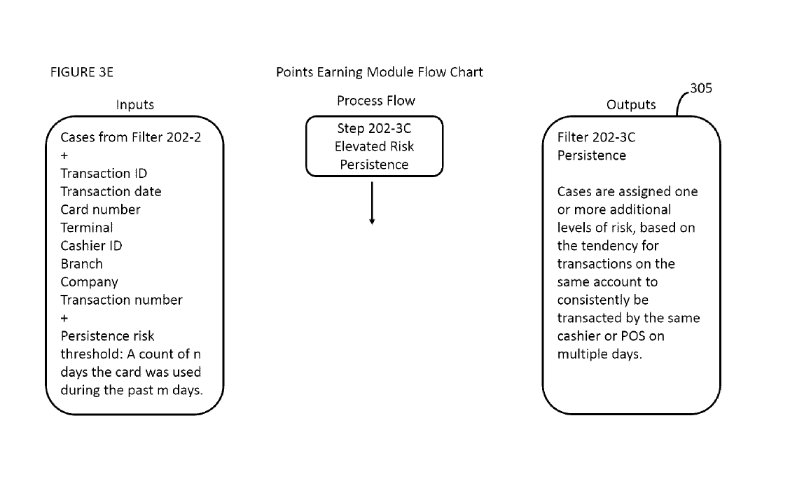

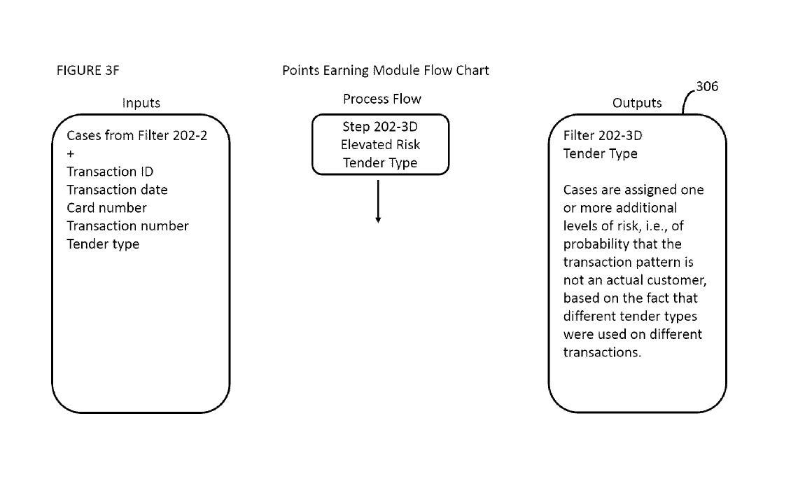

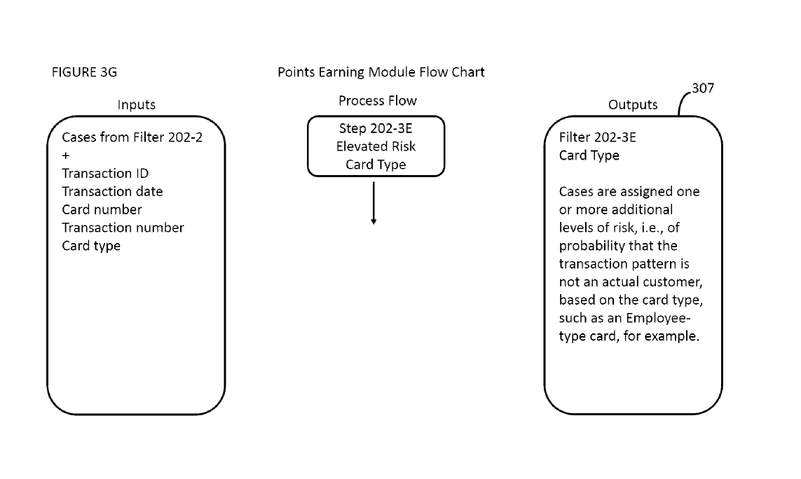

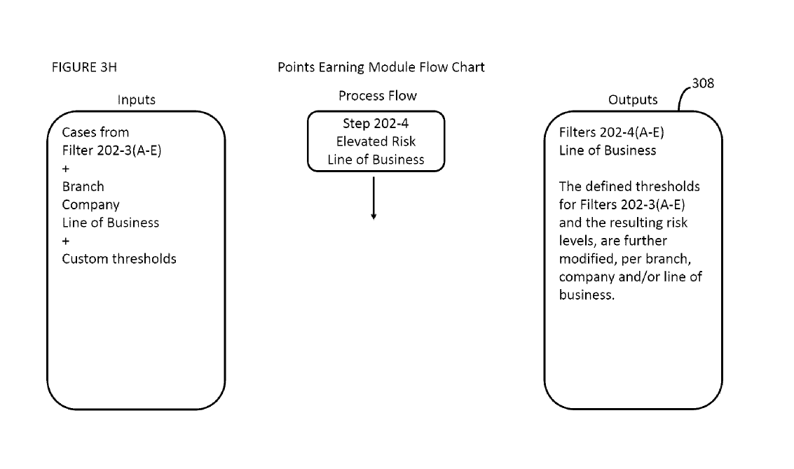

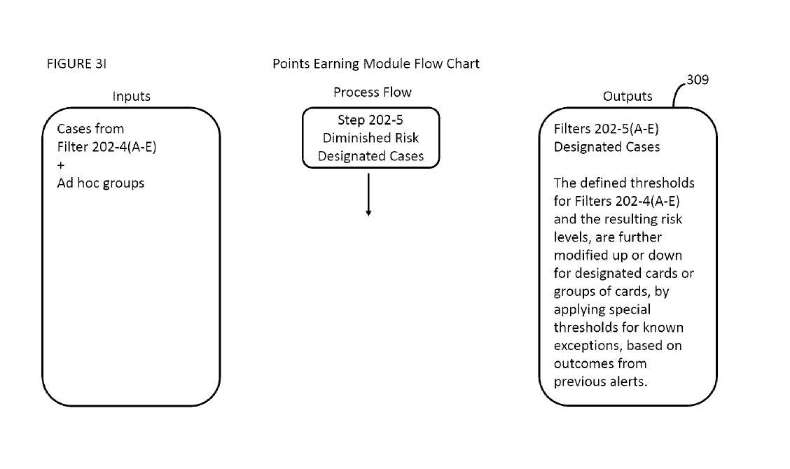

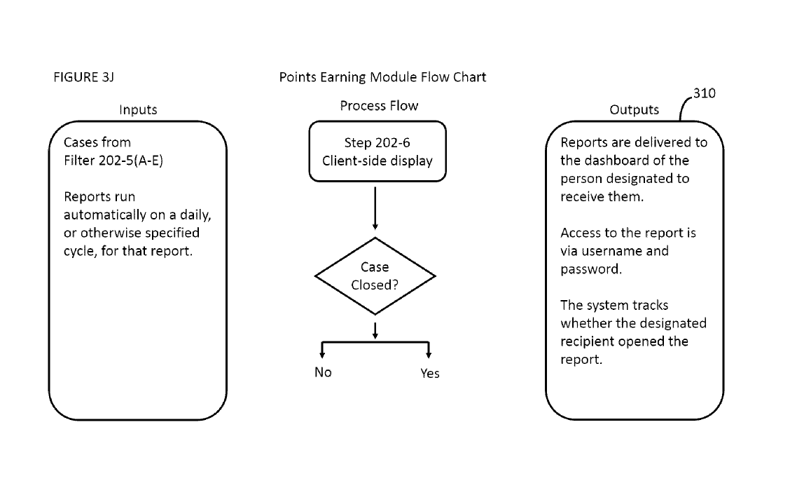

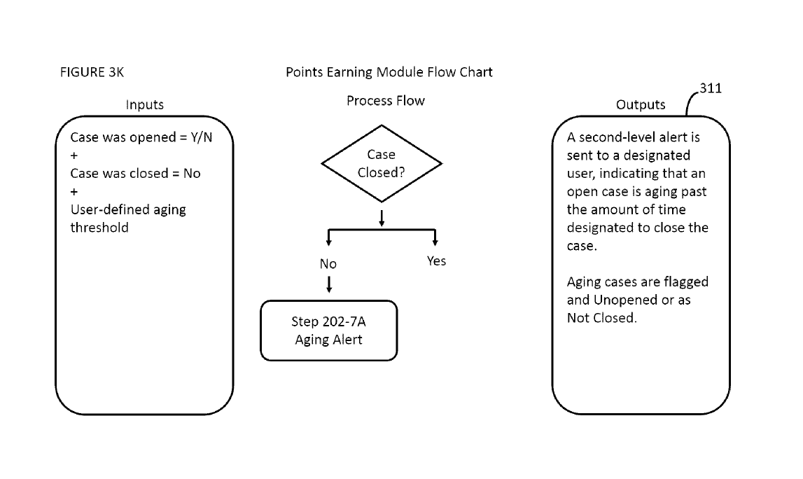

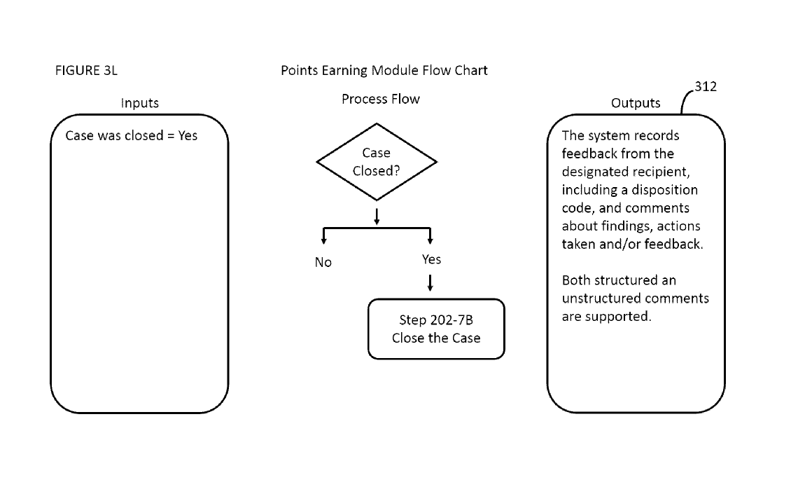

FIG. 3 (FIGS. 3A to 3L) is a flowchart illustrating a process involved in the Points Earning Module for the detection, reporting, and case management of unusual patterns of earning points within a loyalty-rewards program.

The Points Earning Module uses transaction data to identify patterns of points earning that are associated with the crediting of a loyalty-rewards account for transactions not actually made by the holder of the account. For example, an insider, such as a cashier, may use their own loyalty-rewards account to take credit for a transaction made by another person. The module can use a variety of observed patterns which, taken together, are able to automatically identify highly-improbable patterns of points earning. This can potentially reduce both Type I and Type II error as compared to existing methods. Thus, fraudulent activity can be more efficiently identified and reported, helping to reduce wasted efforts by persons responsible, by avoiding the need to review large volumes of false alerts.

In an initial step, the Points Earning Module can access the Application Database 108, the Application Data Structure 106, Web Server Data Structure 112, Data View Structure 101, or another source of electronic data, to review the transaction activity recorded, as depicted in FIG. 3A. FIG. 3A depicts a certain set of data accessed. The data can include, for each transaction, transaction date, transaction time, POS terminal ID, cashier ID, member account type, tender type, and sales channel, branch, store or line of business. However, other types of data can also be accessed and used in a similar manner, such as transaction count, transaction amount, terminal ID, cashier ID, account type, account status, account expiration date, other account activity, account points balance, redeemable or non-redeemable status of points, tender type, sales channel, branch, store, line of business, points transfer donor account (e.g., if points are transferred between donor and recipient accounts), donor account expiration, points transfer target account, target account expiration, elite account status, elite tier level, single-customer-view identifier (e.g., an identifier believed to correspond to a single person over potentially more than one account), date of upgrade (e.g., if an account is upgraded to a different tier level, such as from a normal account to an elite account), original-account create date, most recent renewal date, type of upgrade, and/or a lookup table of qualified or non-qualified gifts, as defined by department, class, sub-class or stock-keeping unit.

In a subsequent, optional step, depicted in FIG. 3B, an account can be filtered according to the number of transactions that have been credited to it. Other criteria can also be used to exclude certain accounts based on inactivity, such as a total value of the transactions credited, a total value of benefits earned, or other criteria. Further, in some embodiments total volume data such as this can be used as one of the factors for determining the likelihood of fraud (similar to those discussed below), instead of being used as a binary filter.

In the steps depicted in FIGS. 3C-3G, the likelihood of fraudulent activity or otherwise erroneous data is estimated, based on one or more additional risk factors, such as a persistent tendency for all transactions to be at the same POS device (including, for example, cash registers) and/or transacted by the same insider (such as the same cashier) 303; a tendency for transactions to persist across an unusually long span of time during a day, wherein the exact definition of a “long span of time” can be a configurable time period (such as, for example, over an hour), based upon a variety of factors, such as store format and line of business, account type, seasonal storewide sale events, or other factors 304; a tendency for transactions to persist over a long span of days, with the same cashier 305, such as more than two days in the same week, for example; the incidence of multiple tender types, such as cash, local credit card and/or international credit card, used in conjunction with the same loyalty or member account 306; and/or use of an account type that would not normally transact in high volumes such as, for example, a special-purpose class of account that is only provided to employees 307.

Using factors such as those described, the likelihood of fraud or data error can be determined in a variety of ways, such as Bayesian statistics, machine-learning algorithms, and the like. The output from these techniques can be a risk score, leading to an ordinal, ratio, or nominal measure of risk of fraudulent activity (or data errors). The reported risk can be expressed on an ordinal or ratio scale, by means of an integer, for example, or it can be expressed using a nominal scale, which may be expressed in the form of words such as “high risk,” “very high risk,” and “severe risk,” or by using color codes, or graphically with a location on a linear scale, or by other signs. The risk score can also include two values (either on an ordinal or nominal scale, as well as discrete values), wherein the two values may indicate, for example, both a probability of fraud and also an estimated financial impact of the potentially fraudulent activity or error. A wide variety of types of risk scores are possible, and these can be adjusted according to factors such as those discussed herein.

According to an example scenario, an account that transacted ten times during the day in a supermarket, may or may not be flagged as unusual or potentially fraudulent, depending upon patterns in that environment and/or other factors. However, if 100% of the transactions on that account on that day were at the same POS, and if transactions were found to have occurred during six different 30-minute intervals across the span of the day, and if the transactions involved a mix of different tender types, such as cash, local credit cards and international credit cards, then the system might report that pattern of points earning as a severe risk of cashier fraud.

Risk scores can be further modified based on different tolerances or thresholds, depending upon the sales channel, branch, store or line of business 308, as depicted in FIG. 3H. For example, purchase frequency may vary significantly by store type or format, so that a pattern of purchases which might be plausible in a particular supermarket chain, for example, might be considered as a severe risk of fraud, if found within an electronics store.

Risk scores can also be modified based on ad hoc groups, for which risk levels can be adjusted, based on specific account characteristics, such as findings from previous investigations 309, as depicted in FIG. 31. For example, an account that was reported on previous alert(s) may have been investigated in the past, and the reasons for the unusual spending pattern may have already been documented. In this case, the system can automatically create an ad hoc group for that account and/or allow designated users to manually place that account into an ad hoc group which they create, and set risk thresholds at a different level for members of that group, in order to avoid repeated false alerts for cases that were already investigated and documented in the past.

As depicted in FIG. 3J, once the risk of fraud or otherwise erroneous data has been determined and meets a predetermined threshold, the system can flag such accounts for further review such as by issuing an alert. In other embodiments, the threshold need not be predetermined, but instead can vary dynamically, such as to match a workload for human reviewers or to meet other business needs or limitations. For example, the system might be configured to deliver up to a maximum pre-set number of alerts to a particular user or set of users in a given time period, and then select the most relevant cases based on that constraint. The system can deliver an alert to the dashboard of the person designated to receive it, with access to the report via username and password, and with system tracking, to determine whether the designated recipient opened the report 310. Said dashboard can show current-day alerts, trend data, and other information. Cases can be viewed by category, such as Unopened, Aging, and Closed. It can also be possible to view transaction histories associated with reported accounts, and to sort and filter the records found in the transaction history. It can also be possible to review individual transactions for any case listed, including transaction details, such as what was purchased or other data discussed herein. Thus, the flagged accounts can be reported to a reviewer, or the reviewer can be otherwise alerted to their presence. Alerts can also be provided in other forms, such as emails, entries in a database or shared document, or other signals.

An authorized user can potentially download a complete or a filtered list of the reported cases into any one of several formats, such as .csv, Excel or PDF.

As depicted in FIG. 3K, the system can also generate a second-level alert to a different user, to flag any potentially fraudulent or erroneous accounts for which the primary person responsible for that case has not reviewed it and/or has not closed the case within the amount of time designated to do so 311. The user who receives the second-level alert can potentially access all of the same report features and views described herein. In some embodiments, access may be limited based on a particular user's role and defined permissions, in order to protect sensitive information and better ensure user privacy. For example, credit card information can potentially be modified by a hash, or cropped or otherwise adjusted, such that a reviewer can identify different credit card numbers without knowing the actual user-identifiable information.

### Points Adjustment Module

The Points Adjustment Module is directed towards a method for the detection, reporting, and case management of unusual patterns of points adjustment within a loyalty-rewards program. This module can be generally similar to the Points Earning Module, but focusing instead on adjustments of benefits (such as points, in the present example) provided to the account by the loyalty-rewards program.

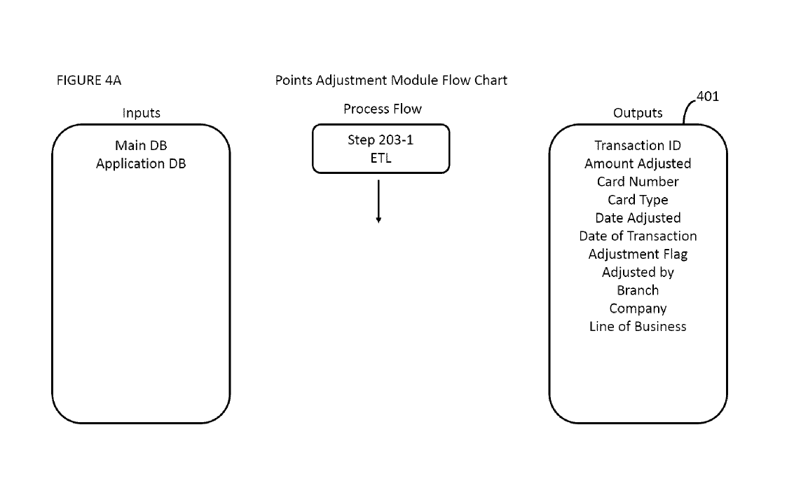

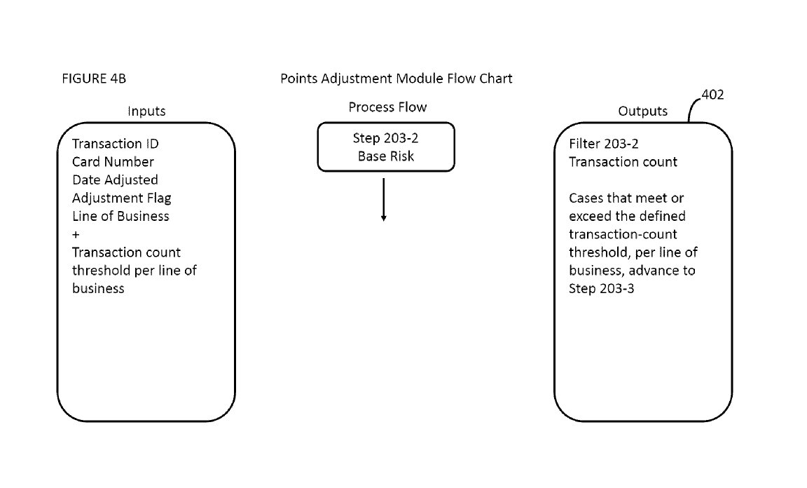

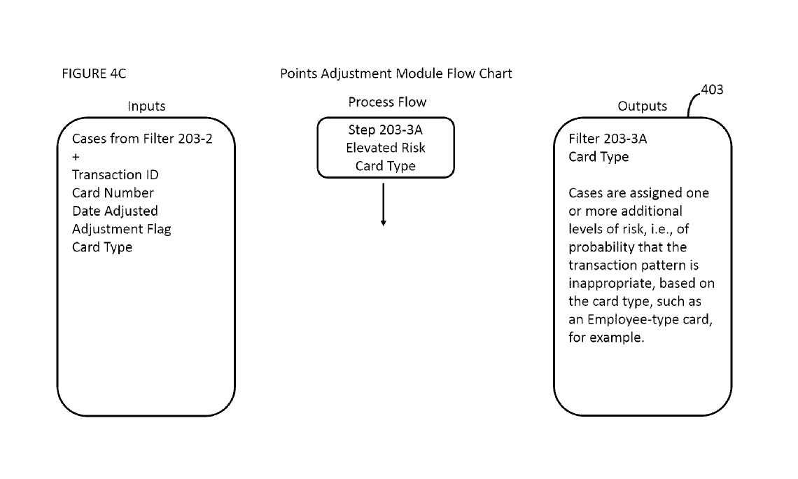

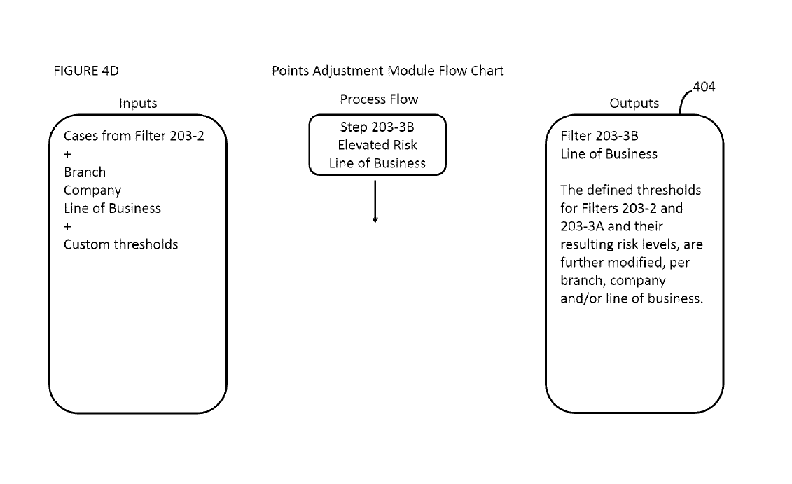

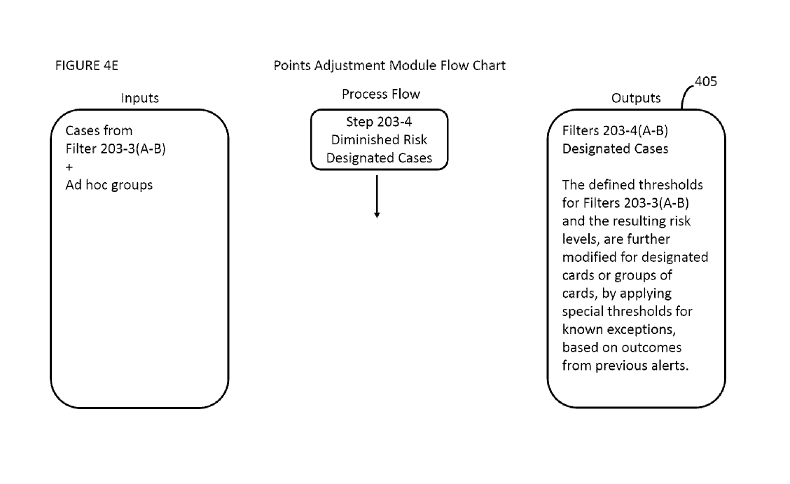

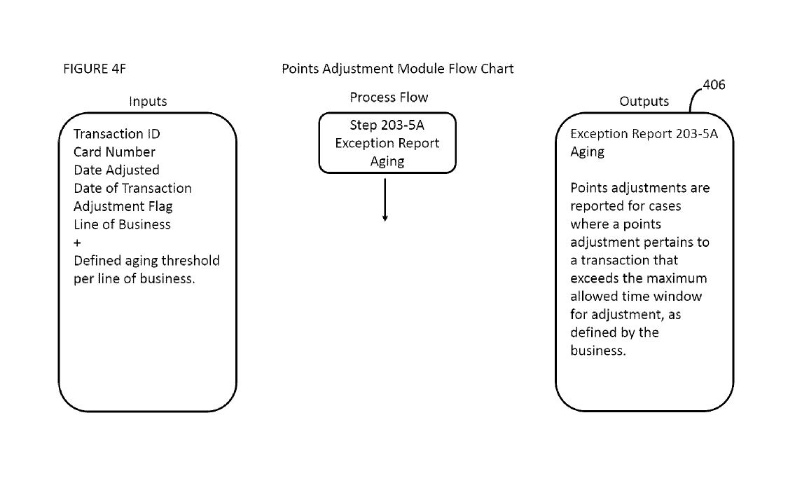

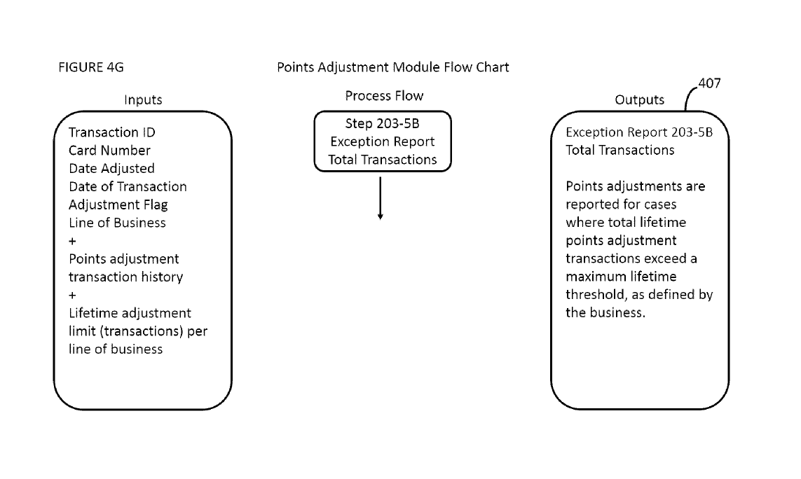

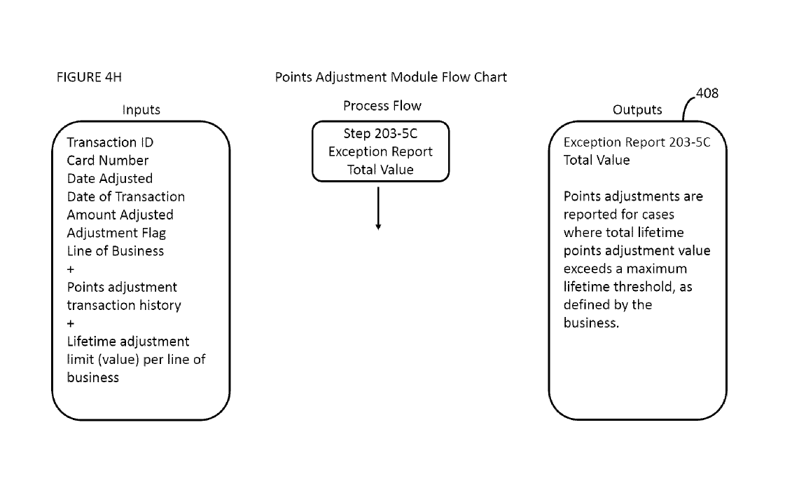

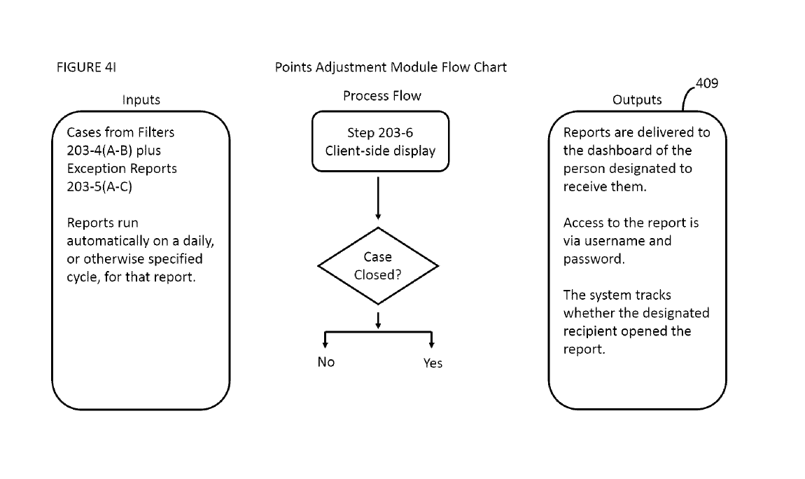

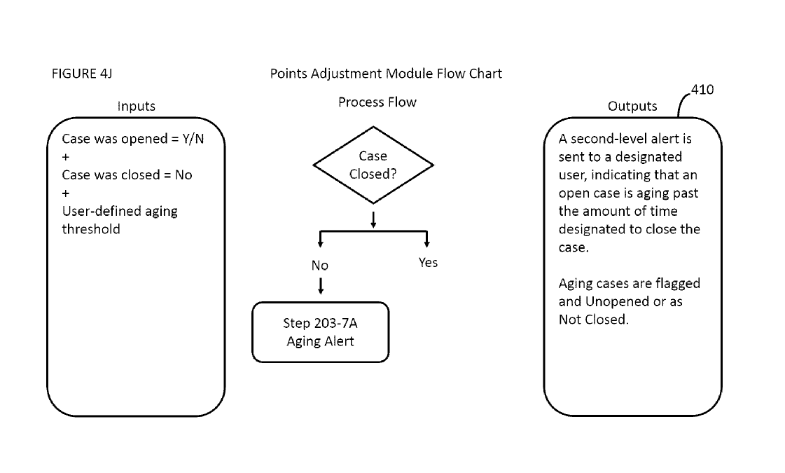

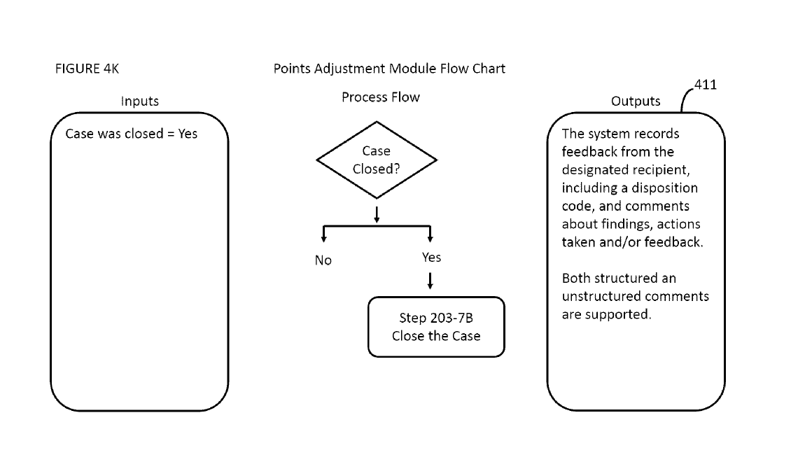

FIG. 4 (FIGS. 4A to 4K) is a flowchart illustrating a process involved in the Points Adjustment Module for the detection, reporting, and case management of unusual patterns of points adjustment within a loyalty-rewards program, whose patterns conform to a conceptual framework describing behaviors indicating a risk of employee misuse, abuse or noncompliance with program rules, such as employee/customer collusion to assign benefits for transactions that might not actually involve the accountholder.

The Points Adjustment Module uses transaction data to identify suspicious patterns of points adjustment 402. The data can include, for each transaction, transaction date, transaction count, transaction amount, member account type, and sales channel, branch, store or line of business. However, other types of data can also be accessed and used in a similar manner. The module can produce various alerts designed to help enforce business rules related to points adjustment. For example, such rules may include an adjustment window, after which points adjustment for a particular transaction is no longer allowed 406.

According to an example scenario, an insider such as an employee, or a non-insider such as a loyalty-rewards accountholder, repeatedly collects receipts left behind by other customers and requests points adjustment to their account to be credited for those transactions, based on the premise that a card associated with their account was not read or that their account was not properly credited for some other reason. The request can be made, for example, by contacting an administrator of the loyalty-rewards program, after the transaction has taken place. In such case, the system can report the resulting pattern of points adjustment as unusual, prompting an investigation.

Similar to the Points Earning Module discussed above, the Points Adjustment Module can begin by collecting data, as indicated at 401 in FIG. 4A. Further, the account can be filtered according to the number of transactions that have been credited to it, using a points adjustment process, as indicated at 402 in FIG. 4B.

The Points Adjustment Module can then adjust an a priori risk score, based on one or more additional factors, such as credit to an employee-type account, or other type of account that would not normally transact in high volumes 403, as depicted in FIG. 4C.

The Points Adjustment Module can further modify risk scores based on different tolerances or thresholds, depending upon the sales channel, branch, store or line of business 404, in a manner similar to that discussed above, regarding the Points Earning Module.

Risk scores can also be modified based on ad hoc groups, for which risk levels can be adjusted, based on findings from previous investigations or for other reasons 405, in a manner similar to that discussed above, regarding the Points Earning Module.

Further, the risk scores can be adjusted and/or the account can be immediately flagged for further review, based on adjustments that relate to transactions for which the time between the request for the adjustment and the date of the transaction exceeds a predetermined maximum allowed time limit for adjustment (for example, a day, a week, etc.), as defined by the business 406; and/or for cases where total lifetime points-adjustment transactions 407 or value 408 exceed a predetermined maximum lifetime threshold.

According to an example scenario, an employee may inadvertently enter a member's account number into a field intended for the amount of points to be adjusted, thereby mistakenly producing a points credit worth many millions, as would happen, for example, in the case of a 16-digit loyalty account number entered into the field for the amount of points to add to the account. In such a case, the system can report the resulting pattern of points adjustment as exceeding a maximum threshold, thereby prompting an investigation to quickly correct the problem.

As in the Points Earnings Module, the system can deliver the alert to the dashboard of the person designated to receive it, with access to the report via username and password, and with system tracking, to determine whether the designated recipient opened the report 409. Said dashboard can show current-day alerts, as well as trend data. It can also be possible to view cases by category, such as Unopened, Aging, and Closed. It can also be possible to view transaction histories associated with reported accounts, and to sort and filter the records found in the transaction history. It can also be possible to review individual transactions for any case listed, including the transaction details, as described previously.

An authorized user can potentially download a complete or a filtered list of the reported cases into any one of several formats, such as .csv, Excel or PDF.

The system can also generate a second-level alert to a different user, to flag any cases of potentially fraudulent accounts for which the primary person responsible for that case had not opened it and/or had not closed the case within the amount of time designated to do so 410. The user who receives the second-level alert can potentially access all of the same report features and views described herein.

Further, the Points Earning Module and the Points Adjustment Module can optionally be partially or fully combined in various ways that, in some embodiments, may further enhance user insight about specific rewards accounts, or that may enhance the convenience or functionality of the application, as compared to a series of stand-alone modules.

### Points Transfer Module

The Points Transfer Module is directed towards a method for the detection, reporting, and case management of unusual patterns of points transfer between different accounts within a loyalty-rewards program. This module can be generally similar to the Points Earning Module and the Points Adjustment Module, but instead focusing on the transfer of benefits, such as points, from one loyalty-rewards account to another loyalty-rewards account.

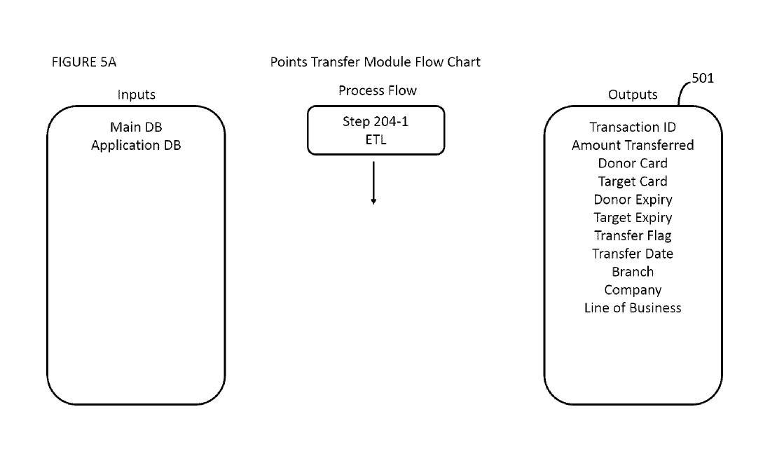

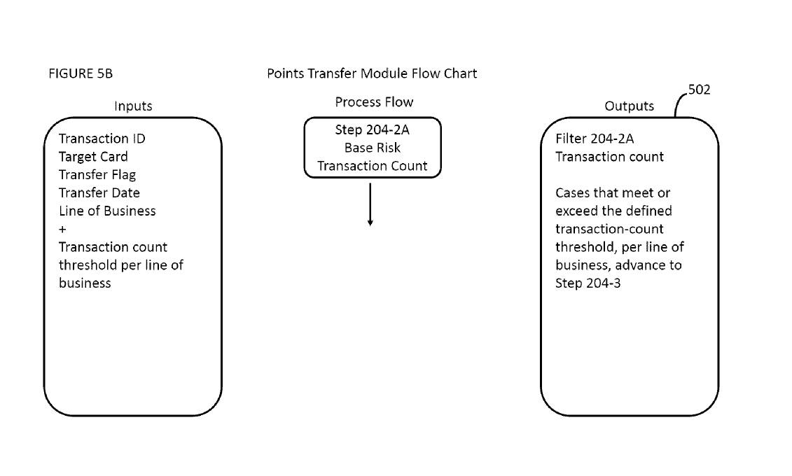

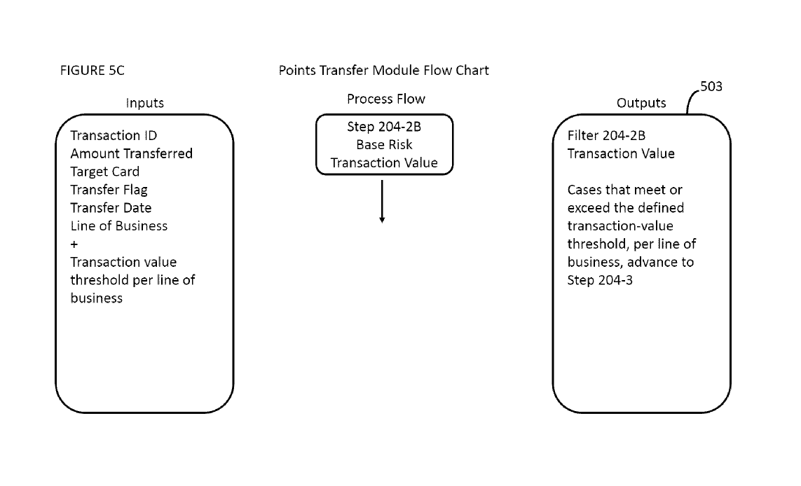

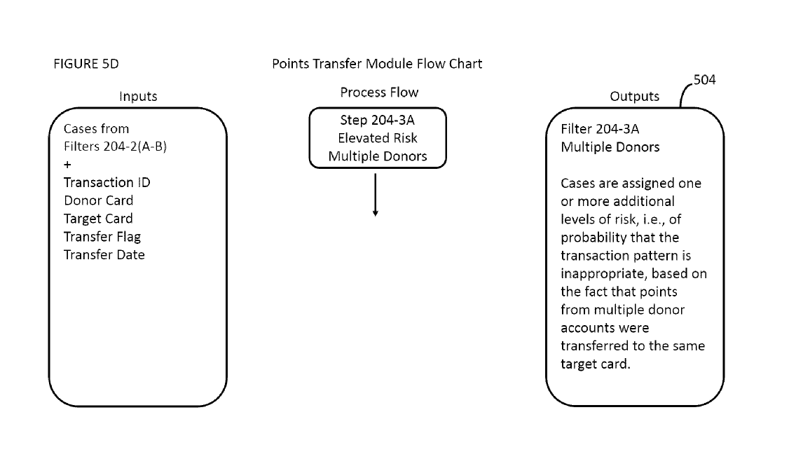

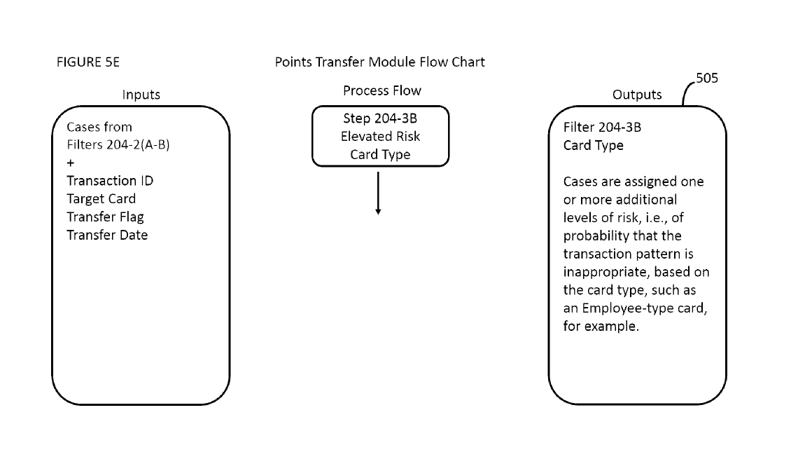

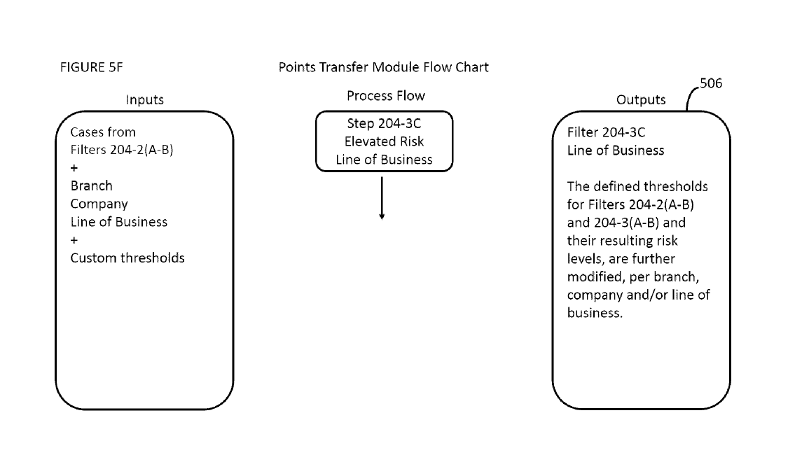

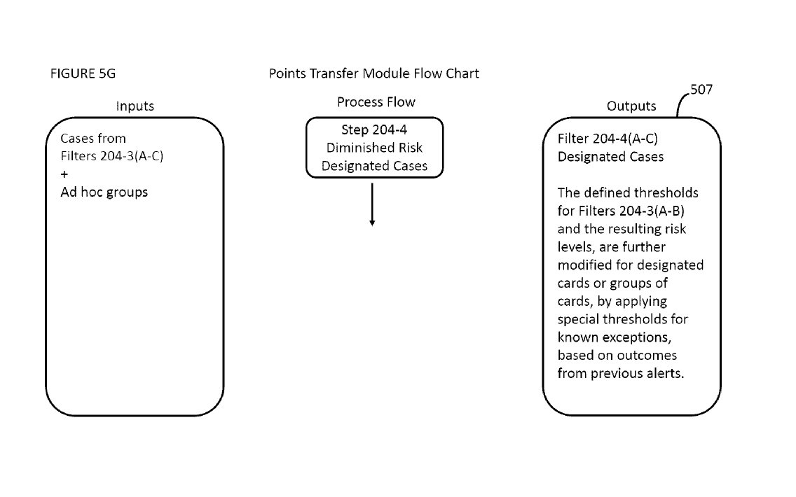

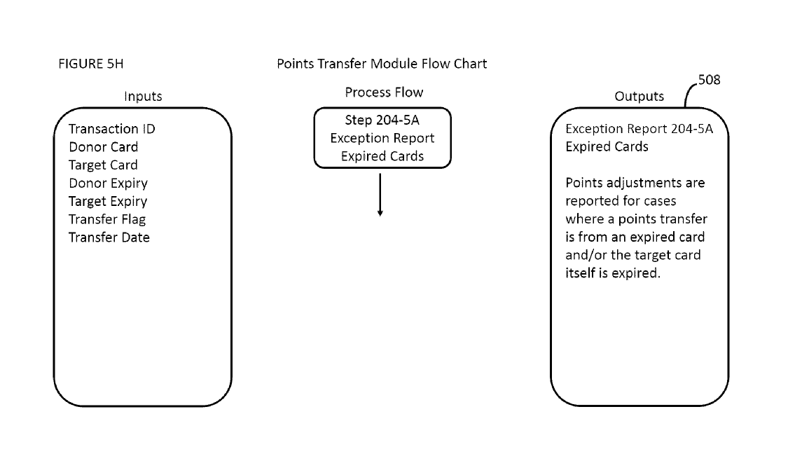

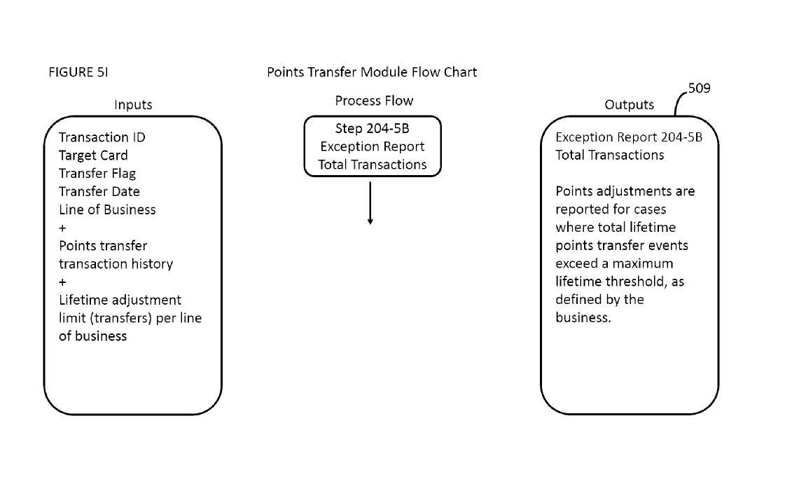

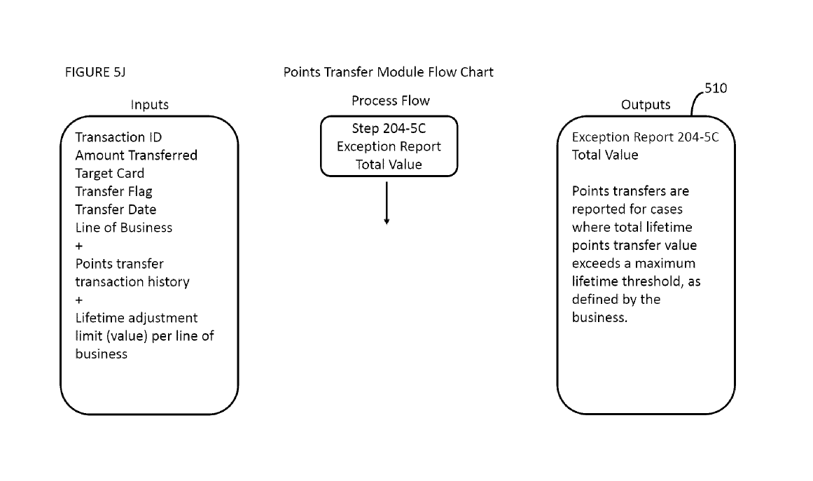

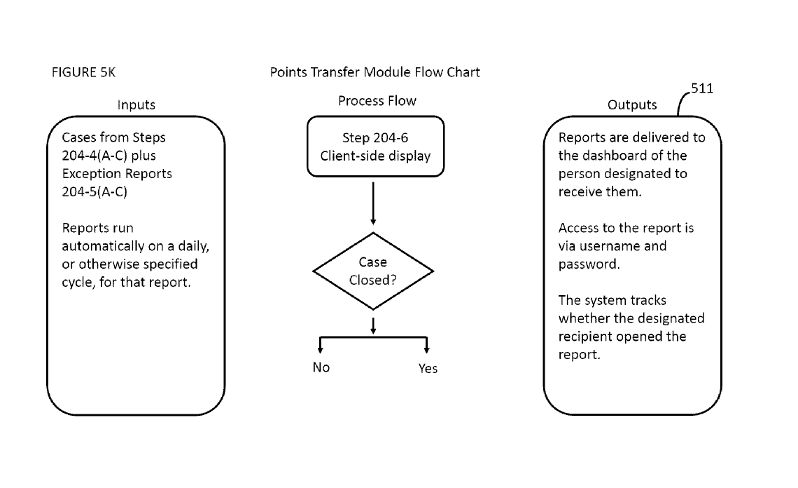

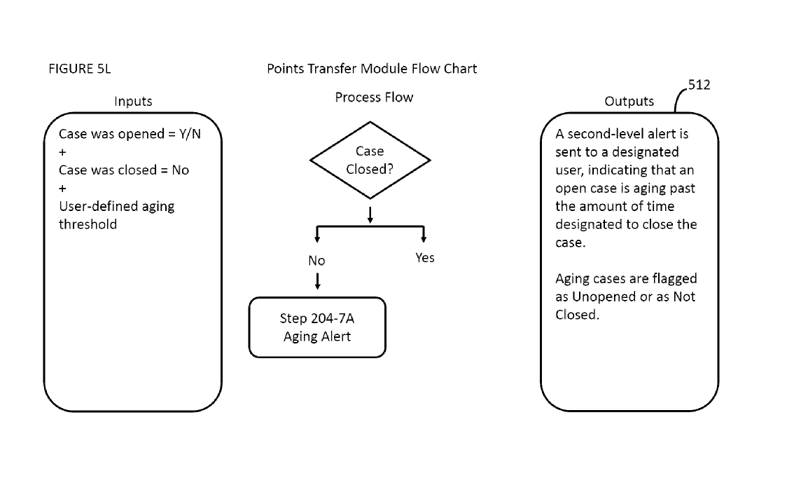

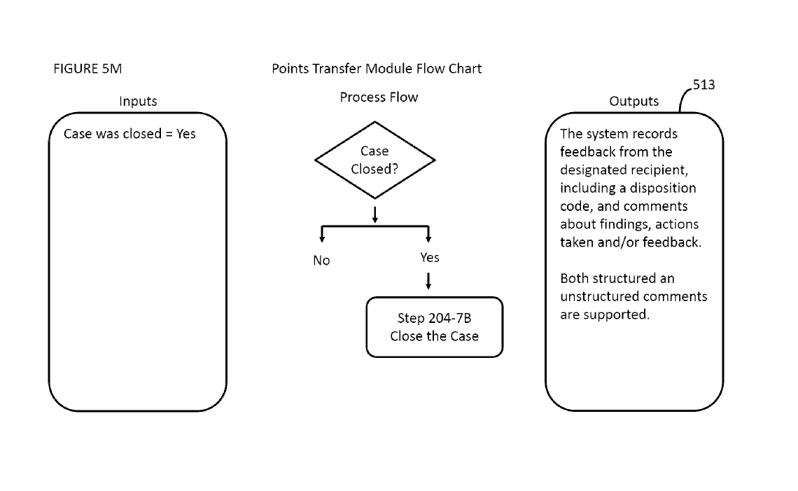

FIG. 5 (FIGS. 5A to 5M) is a flowchart illustrating a process involved in the Points Transfer Module for the detection, reporting, and case management of unusual patterns of points transfer within a loyalty-rewards program, whose patterns conform to a conceptual framework describing behaviors indicating a risk of employee misuse, abuse or noncompliance with program rules.

The Points Transfer Module uses transaction data to identify suspicious patterns of points transfer that are associated with insider fraud and/or insider/customer collusion. The data can include transaction date, transaction count, transaction amount, donor account, donor account expiration, target account, target account expiration, and sales channel, branch, store or line of business. However, other types of data can also be accessed and used in a similar manner. The module produces various alerts designed to help enforce business rules related to points transfer. Such rules can include a stipulation that points cannot be transferred to or from expired accounts, as indicated at 508 in FIG. 5H.

As discussed above for other modules, data can be initially loaded 501 and accounts can be filtered according to the number of transactions (in this case, including transfers of benefits) that have been executed with each account, or the total value of benefits transferred to or from an account 502, 503. A priori risk of fraud or error (such as a risk of fraud or error based solely on the number of transactions associated with an account) is adjusted based upon additional risk factors, such as if points from multiple donor accounts are transferred to the same target account 504 and/or based on involvement of a higher-risk account category, such as an Employee type account 505.

According to an example scenario, an insider such as an employee, acting alone or in collusion with an account holder, monitors inactive accounts with large points balances and transfers points from such accounts to a target account, immediately prior to points expiration. In such case, an embodiment of the present invention would report the resulting pattern of points transfer as a severe risk, due to the fact that multiple transfers involve multiple unrelated donor accounts, following a pattern that conforms to a conceptual framework about this type of fraud.

The Points Transfer Module can further modify risk scores, based on different tolerances or thresholds, depending upon the sales channel, branch, store or line of business 506.

The Points Transfer Module can deliver alerts that pertain to transfers for which points are from an expired card and/or transfers for which the target card itself is expired 508.

The Points Transfer Module can also deliver alerts that pertain to transfers for which total lifetime points transfer events 509 or value 510 exceed a predetermined maximum lifetime threshold, as defined by the business.

The Points Transfer Module can further modify decision rules and/or risk scores for accounts that are members of ad hoc groups which can be created based on specific account characteristics, such as findings from previous investigations, for example 507.

According to an example scenario, a program creates a process for members to optionally transfer unused points to the account of a designated charity. In such case, an embodiment of the present invention might apply a different exception criteria for that target account, based on a known program feature.

Accounts with high risk scores can be flagged and alerts can be created in a manner similar to those described above regarding the Points Earning Module and the Points Adjustment Module. Further, these modules can be partially or fully combined, as described above.

### Gift Redemption Module

The Gift Redemption Module is directed towards a computer-implemented method for the detection, reporting, and case management of unauthorized patterns of gift redemption within a loyalty-rewards program. The Gift Redemption Module can produce alerts designed to help monitor compliance with various business rules associated with this activity.

The Gift Redemption Module can, for example, deliver alerts that pertain to redemptions which were done by a non-qualified account type or status, such as a temporary account; or which were from an account that is suspended or expired; or which were from a class of points on an account that are suspended or expired; or that were done by an account that did not yet meet a minimum transaction, activity or spending requirement; or which were for a benefit that is disallowed for that purpose under the rules of the program. The data for this module can include account expiration date; account type; account status; transaction history; account activity; a lookup table of qualified or non-qualified gifts, as defined by department, class, sub-class or SKU; and sales channel, branch, store or line of business, in which the points were earned or redeemed. However, other types of data can also be accessed and used in a similar manner.

According to an example scenario, a program might have a rule which does not allow temporary accounts to redeem for rewards until after they have been converted to permanent status. In many environments, such a rule would presumably be enforced by the rewards redemption system itself, but in some environments such a rule may merely be enforced by a standard operating procedure (“SOP”) to that effect. Regardless of the case, if a reward is obtained by an account class that does not qualify for rewards under the rules of a program, then the system can report such a redemption as unauthorized.

Further, the system can define approved rewards either affirmatively or as exclusions. Thus, a list of qualified gifts can be defined at a department, class, sub-class and/or stock-keeping unit (“SKU”) level; or in the alternative, a list of nonqualified benefits (rather than qualified benefits) can be defined. In addition, qualified benefits can be defined independently, either affirmatively or as exclusions, per sales channel, branch, store, or line of business, such that the approach to define qualified benefits can be affirmative in some environments and exclusionary in others, even within the same loyalty-rewards program.

According to an example scenario, one line of business may have designated only thirty authorized gifts which are hand-selected per store, whereas a different line of business within the same program might allow redemption for anything and everything sold in the store, except gift cards. In such a case, the system can allow users to selectively enroll the authorized gift rewards per store in the first environment, while also supporting the selective exclusion of just the gift card SKU, for the second line of business, thereby facilitating ease of administration for users of the rules engine.

The system can also modify the business rules for authorized gift redemption, based on ad hoc groups of participants or members, so that the approved redemption rules can be different for different sub-groups of members, regardless of whether such groups had been pre-defined as such within the program structure, by means of distinct ranges of account numbers.

Transactions violating the rules set forth can be flagged and alerts can be created in a manner similar to those described above regarding the Points Earning Module and the Points Adjustment Module. Further, these modules can be partially or fully combined, as described above.

### Points Exception Module

The Points Exception Module is directed towards a computer-implemented method for the detection, reporting, and case management of unexpected points values or other benefits within a loyalty-rewards program. For example, the Points Exception Module may produce alerts that flag accounts that have expired, but which still have points balances that are in a redeemable status. This module produces at least two different filters—one for soft-expired points, such as points on an expired account that is still within a late-renewal grace period; and one for hard-expired points, for accounts that are beyond any renewal grace period. The data for this can include, for each account record, member account number, elite account number, elite tier level, single-customer-view identifier, date of upgrade, original account create date, most recent renewal date, transaction activity, type of upgrade, system user who made the change, and location of upgrade. However, other types of data can also be accessed and used in a similar manner.

The Points Exception Module can sub-classify the points found on expired accounts as in a redeemable or in a suspended state.

Further, the Points Exception Module can report any accounts that have an unexpected points balance such as, for example, a sudden and/or improbable increase in the value of points on the account, or a balance on the account of less than zero.

According to an example scenario, a member may have returned an item for a refund after having already spent all the points that were earned as a result of the refunded purchase. After the refund, the member's account might show a negative balance. In such case, the system can report the negative points balance on the account, prompting an investigation to correct the problem.

Accounts with unexpected points values or other unexpected benefits can be flagged and alerts can be created in a manner similar to those described above regarding the Points Earning Module and the Points Adjustment Module. Further, these modules can be partially or fully combined, as described above. For example, an unusual increase in points value on an account might be evaluated in light of patterns found in the Points Adjustment and/or Points Transfer Modules, in order to provide an additional layer of insight about risk and/or about root cause of the pattern.

### Upgrade Exception Module

The Upgrade Exception Module is directed towards a computer-implemented method for the detection, reporting and case management of nonconforming member-status upgrades to a higher tier level within a loyalty-rewards program. The Upgrade Exception Module produces alerts that flag cases of accounts that were upgraded to a higher tier level, such as gold or elite status, for which the amount spent during the qualifying period was less than the required amount, based on pre-defined program rules.

The Upgrade Exception Module can report nonconforming member-status upgrades, such as when a front-line employee provides complimentary upgrades to preferred tier status as a favor to a friend or as an accommodation, in order to placate an irate customer (which might not be the problem resolution approach defined by the program).

The Upgrade Exception Module can also further sub-classify the reported upgrades, based on a reason code or other identifier, showing reasons given for upgrade. For example, within some programs, store managers may have discretion to assign higher rewards tiers to VIPs or bloggers, so the module can report this as the reason for non-qualified upgrade, if applicable.

The accounts can be flagged and alerts can be created in a manner similar to those described above regarding the Points Earning Module and the Points Adjustment Module. Further, these modules can be partially or fully combined, as described above.

### Support Processes

The User Management Module 114 allows authorized users to create and modify user names, passwords and roles; set or modify the designated recipients for each report type; set or modify the report cycle per report type; and set the minimum number of days for the designated recipient to close out a case.

The Admin Module 201 allows authorized users to define the thresholds and the associated levels of risk, if applicable, per line of business, for each of the reporting and alert modules described above.

The teachings provided herein can be applied to other systems, not necessarily the systems described above. The elements and acts of the various embodiments described above can be combined to provide further embodiments. While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. Accordingly, the scope of the present disclosure is defined only by reference to the appended claims.

1. A method for detecting, reporting and managing cases of loyalty and rewards program fraud or cases of erroneous data within human-assisted payment environments, such as physical retail locations or telephone-assisted payment or booking environments, or in any environment where the true accountholder may not be defined or known, the method pertaining specifically to fraudulent earning of rewards points or equivalent benefits by insiders, based on the purchases of others, and/or fraudulent access to member discounts or equivalent benefits by persons who are not entitled to such benefits, the method comprising:
receiving, by a computing system having one or more hardware processors, electronic data regarding a plurality of transactions associated with one or more related loyalty-rewards accounts at one or more points-of-sale;
determining, by the computing system, a risk that the one or more loyalty-rewards accounts was erroneously credited, by an insider, for one or more transactions not made by an accountholder of the one or more loyalty-rewards accounts, based at least on the electronic data; and
reporting the one or more loyalty-rewards accounts to a system user for further review if the determined risk that the one or more loyalty-rewards accounts was erroneously credited reaches a predetermined threshold.

2. The method of claim 1, wherein the risk is determined by transaction counts and/or amounts transacted, in combination with at least one or more additional risk factors, such as cashier ID, POS terminal ID, inter-day and intra-day pattern of transaction dates and times, homogeneity or lack of homogeneity of tender type for different transactions on the same account, and consolidated results from a unifying single-customer-view identifier.

3. The method of claim 2, wherein the risk is also determined by the percentage of transactions conducted by the same cashier on the same loyalty-rewards account.

4. The method of claim 2, wherein the risk is also determined by the percentage of transactions conducted at the same point-of-sale machine on the same loyalty-rewards account.

5. The method of claim 2, wherein the risk is also determined according to if multiple transactions on the same loyalty-rewards account occurred for an unusually extended period of time during the day.

6. The method of claim 2, wherein the risk is also determined according to if multiple transactions occurred over an unusually extended period of days, with the same cashier on the same loyalty-rewards account.

7. The method of claim 2, wherein the risk is also determined according to if the loyalty-rewards account belonged to a higher-risk category, such as an employee-type account.

8. The method of claim 2, wherein the risk is also determined according to the incidence of multiple tender types on different transactions during the day, such as cash, local credit card or international credit card, used in conjunction with the same loyalty-rewards account.

9. The method of claim 2, wherein the predetermined threshold depends upon the sales channel, branch, store or line of business.

10. The method of claim 2, wherein the predetermined threshold depends on whether or not a loyalty-rewards account belongs to a system-defined ad hoc group, for which the risk parameters may be different than for other loyalty-rewards accounts under similar conditions.

11. The method of claim 10, wherein the method is repeated, and membership in an ad hoc group is determined based on findings from previous reviews initiated in response to previous instances of the reporting step.

12. The method of claim 1, wherein the determined risk additionally comprises the risk of fraudulent rewards points adjustment activities.

13. The method of claim 1, wherein the determined risk additionally comprises the risk of fraudulent rewards points transfer activities.

14. The method of claim 1, further comprising reporting, for further review, non-normative changes in account balances, such as a balance decrease to less than zero or a balance increase that exceeds a limit based on standard deviations from normative changes in account balances.

15. The method of claim 1, further comprising reporting, for further review, accounts that were promoted to a higher tier level without meeting a business rule established for such status.

16. The method of claim 1, further comprising reporting, for further review, rewards redemption activities by a non-qualified account type or status, such as a temporary or suspended account, or using expired points.

17. The method of claim 1, further comprising reporting, for further review, rewards redemption activities for an item that is not allowed as a reward under a program's rules.

18. The method of claim 1, wherein the step of reporting comprises delivering a report to a dashboard of a user designated to receive it, and further comprising tracking the report to determine whether the designated recipient opened the report.

19. The method of claim 18, further comprising delivering a second-level alert to a different user, when the user designated to receive the report has not viewed the report, or has not acted on the report within an amount of time designated to do so.

20-102. (canceled)
